(19) United States
(12) Patent Application Publication
(10) Pub. No.: US 2026/0229013 A1
(43) Pub. Date: Aug. 6, 2026

(54) CLASSIFYING AND TRACKING ORBITAL DEBRIS OBJECTS USING AN OPTICAL CAMERA

(71) Applicant: University of Utah Research Foundation, Salt Lake City, UT (US)

(72) Inventors: Neda NATEGH, Salt Lake City, UT (US); Yasin ZAMANI, Salt Lake City, UT (US)

(21) Appl. No.: 19/146,164

(22) PCT Filed: Jan. 5, 2024
(86) PCT No.: PCT/US2024/010522

§ 371 Date: Jul. 7, 2025

Related U.S. Application Data
(60) Provisional application No. 63/437,313, filed on Jan. 5, 2023.

(51) Int. Cl. G06V 10/764; G06T 7/246; G06T 7/60

(52) U.S. Cl. CPC G06V 10/764; G06T 7/246; G06T 7/60; G06T 2207/10016

(57) ABSTRACT

Technology is described for a method for tracking orbital debris objects using an optical camera. The method can include identifying (2610) a location and brightness for a plurality of spots with various motion features and trajectories over ranges of background conditions in an image sequence from the optical camera. A centroid location can be computed (2620) for each of the plurality of spots and associated brightness values using a plurality of image frames. Another operation may be classifying (2630) the plurality of points as debris objects using centroid data from the plurality of frames. The plurality of classified debris objects can be tracked (2640) in near real-time over a time period.

### CROSS REFERENCE TO RELATED APPLICATIONS

This application claims priority to U.S. Provisional Application. No. 63/437,313, filed Jan. 5, 2023.

### STATEMENT REGARDING FEDERALLY SPONSORED RESEARCH OR DEVELOPMENT

Not Applicable.

### NAMES OF THE PARTIES TO A JOINT RESEARCH AGREEMENT

Not Applicable.

### INCORPORATION BY REFERENCE STATEMENT

Not Applicable.

### BACKGROUND

After more than 50 years of human space activities, orbital debris has become a serious problem in the near-Earth environment. The U.S. Space Surveillance Network is currently tracking more than 22,000 objects larger than 10 centimeters (cm). Additional optical and radar data indicate that there are about 500,000 pieces of debris larger than 1 cm (centimeter) and more than 100 million pieces of debris larger than 1 millimeter (mm) in orbit. Currently, space debris is mainly tracked using on-Earth sensors including radar systems and optical telescopes.

National Aeronautics and Space Administration (NASA) and the Department of Defense (DoD) cooperatively characterize the orbital environment. DoD's Space Surveillance Network actively tracks approximately 20,000 pieces of debris orbiting Earth with a size greater than 10 cm. NASA uses additional ground-based sensors and inspections of returned satellite surfaces to estimate the number of untracked debris particles smaller than 10 cm. NASA's statistical analysis predicts there are between 300,000 to 600,000 debris particles orbiting earth that are smaller than a softball. These small, untracked debris objects (500,000) outnumber the larger and tracked objects (20,000) by a ratio 25 to 1. These objects may be too small to track but too large to shield against. Therefore, the risk of the small untracked debris objects to operational spacecraft is much higher than the risk posed by the larger and tracked debris objects. Low Earth Orbit (LEO) has the highest concentration of both active satellites and debris, thus increasing the probability of objects colliding.

FIG. 1 illustrates the estimated locations of space debris, highlighting their concentration in LEO. These two computer-generated orbital debris images display currently tracked debris objects. Approximately 95% of the objects in these images are orbital debris and are not functional satellites. The dots represent the current location of each item. On the left of FIG. 1, Geosynchronous Earth Orbit (GEO) is depicted, and on the right, Low Earth Orbit (LEO) is depicted.

The NASA Marshall Space Flight Center (MSFC) has focused its efforts on small orbital debris ranging in size from 5 mm to 10 cm as debris of these sizes presents the greatest threat to operational spacecraft as they are too small to track but too large to shield against. Analysts at MSFC have begun to characterize the small debris environment in LEO to support addressing the characterization, mitigation, and ultimate removal of small debris. The Small Orbital Debris Active Removal (SODAR) architectural study investigated the overall effectiveness of removing small orbital debris from LEO using a low power, space-based laser.

### BRIEF DESCRIPTION OF THE DRAWINGS

FIG. 1 illustrates the estimated locations of space debris, highlighting their concentration in LEO.

FIG. 2 is an example of a pseudocode illustrating a method for classification.

FIG. 3 illustrates an example flow chart of the classification process with inputs denoted at each block.

FIG. 4 is a block diagram illustrating is an example of pseudocode for a method of determining centroids for spots.

FIG. 5 is an example of pseudocode for calculating a distance matrix.

FIG. 6 illustrates an example of pseudocode for computing the correspondence or matching between centroids in the current frame versus those in the previous frame using the distance matrix.

FIG. 7 illustrates an example of pseudocode for computing translation vectors.

FIG. 8 illustrates an example of pseudocode for calculating object rotations.

FIG. 9 illustrates an example of pseudocode for feature extraction.

FIG. 10 illustrates an example of pseudocode for identifying outliers.

FIG. 11 illustrates an example of pseudocode for labeling spots.

FIG. 12 is an example flow chart illustrating tracking operations.

FIG. 13 illustrates an example of pseudocode representing operations in the tracking process.

FIG. 14 illustrates an example of pseudocode for selecting objects.

FIG. 15 illustrates an example of pseudocode for assigning tags.

FIG. 16 is a table illustrating information about tested sets of sample data.

FIG. 17 illustrates sample video stills of a star field.

FIG. 18 illustrates that the performance of the classification algorithm can be measured using a confusion matrix.

FIG. 19 summarizes the results of applying the classification algorithm on each of the datasets in FIG. 16, which report various performance measures presented in FIG. 18.

FIG. 20 illustrates the reported performance of the tracking process, measured as the average accuracy across all the frames in the input video data for all the sample datasets described in FIG. 16.

FIG. 21 is a block diagram illustrating an example of a summary of the processing method that can be performed to identify objects.

FIG. 22 illustrates that a process can binarize image I using threshold t.

FIG. 23 illustrates determining the centroid of each spot using the detected white pixels and a connected component marking an area is found in the image that each spot covers.

FIG. 24 illustrates an example distance matrix.

FIG. 25 illustrates a triangulation process for the technology.

FIG. 26 is a flowchart illustrating an example summary of classifying and tracking orbital debris objects using an optical camera.

FIG. 27 illustrates a computing device which may execute the foregoing operations of this technology.

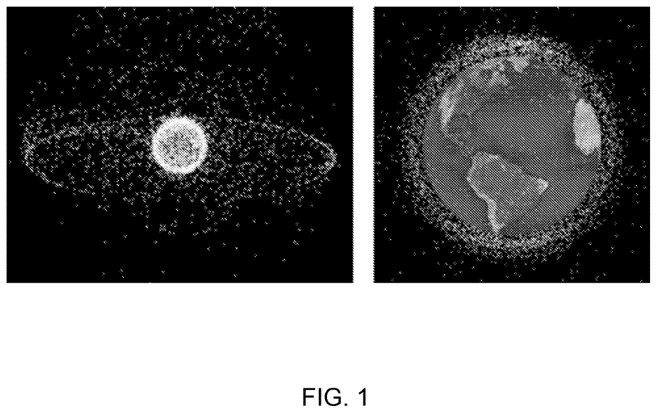

### DETAILED DESCRIPTION

Reference will now be made to the examples illustrated in the drawings, and specific language will be used herein to describe the same. It will nevertheless be understood that no limitation of the scope of the technology is thereby intended. Alterations and further modifications of the features illustrated herein, and additional applications of the examples as illustrated herein, which would occur to one skilled in the relevant art and having possession of this disclosure are to be considered within the scope of the description.

There may be some gaps in technologies currently used for orbital debris tracking and characterization. There is a desire to have technologies that are able to: (1) track and characterize debris that is 10 to 100 times smaller than debris currently being tracked; and (2) reduce tracking time to accommodate the larger number of targets being tracked.

The Small Orbital Debris Detection, Acquisition, and Tracking (SODDAT) conceptual technology demonstration spacecraft was developed to address the challenges of in-situ small orbital debris environment classification including debris observability and instrument features for small debris observation. These studies have identified the ability to detect and precisely track small LEO objects from a space-based platform as an important aspect of supporting spacecraft systems.

To address these challenges, this technology focuses on detection and tracking small orbital debris ranging in size from 5 mm to 10 cm using a lower-cost space-based orbital debris tracking system.

The present technology may have an optical camera on a satellite which is able to quickly and accurately detect small and faint space debris. Optical images may be taken from orbit, and from those images, spots that are a star or an object may be classified. Processes may be used to determine the orbital elements and their physical properties such as position, speed, size, and rotation of the object. The process may compare an item or spot to the list of known objects, to determine if the item is a new object or a previously tracked object (if the computation power is available in an orbiting vehicle or satellite).

The vision-based system may be composed of two major components, a classification algorithm and a tracking algorithm. The classification algorithm may identify pixel location and brightness information for everything detectable and relevant in the field of view (FOV) of an optical camera captured in a video sequence from an orbiting vehicle or satellite. This pixel information can be used to compute the centroid location of each spot in each camera frame and their associated brightness values.

The centroid data can then be used by a statistical classifier for differentiating between stars and debris objects in the set of detected spots. The classifier takes successive camera frames as input and determines which detected values are debris objects.

Next, the tracking process locates classified debris objects in consecutive frames and tracks them over time. The processes can perform accurately and robustly in challenging environments such as: a moving star background, multiple moving objects, objects with various moving trajectories and speeds, and occlusion of spots. The process can also be computationally tractable for on-orbit calculations. The accuracy of the process can be displayed across a variety of image conditions, movement patterns and dynamics.

The technology has been validated and optimized using testing capabilities and space debris images. For example, the one-of-a-kind Dynamic Star Field Simulator (DSFS developed and maintained by NASA) uses a high resolution large monochrome display and a custom collimator that is capable of projecting realistic star images with simple orbital debris spots (down to star magnitude 11-12) into a passive orbital detection and tracking system with simulated real-time angular motions of a vehicle-mounted sensor. The DSFS can be expanded for multiple sensors (including advanced star trackers), real-time vehicle pointing inputs, and more complex orbital debris images. Images from the DSFS can serve as inputs to the detection technology for tracking simulated small orbital debris objects.

This machine vision-based classification and tracking method can be used to detect and track small (e.g., 5 mm to 10 cm) and faint space debris, quickly and robustly, using videos captured by an optical camera from an orbit. The tracking method may be used on a constellation of small satellites in LEO, which can enable detection of debris outside of the presence of atmospheric scintillation to achieve higher precision than prior systems.

The classification process can identify the bright spots in captured video sequences and classify them as “objects” (representing orbital debris objects) or “stars”. In cases where the classification process is not able to classify the detected spots into one of the objects or stars types, then that spot may be labeled as “unknown”, which is neither the objects class nor the stars class.

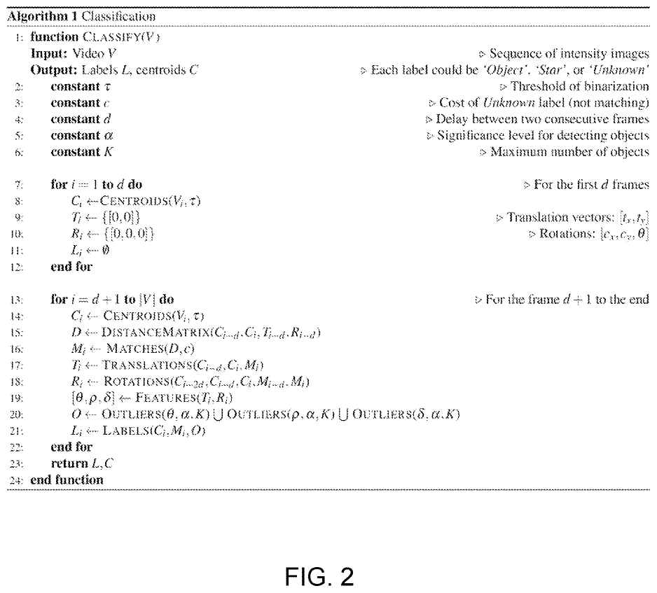

The input to the classification process can be a sequence of intensity images over time, which may represent the captured space videos. FIG. 2 illustrates an example of pseudocode for the classification process operations.

To classify spots in each image frame, the first step is to determine the position of the spots in each frame. Using grayscale images as the input, each pixel value between 0 and 1 in the image represents the light intensity at that pixel, with larger values representing brighter pixels. A global intensity threshold value can be chosen such that the global intensity threshold value can remove as many noisy pixels as possible in the input frames. Using this threshold value, input grayscale images can be converted into binary black and white images.

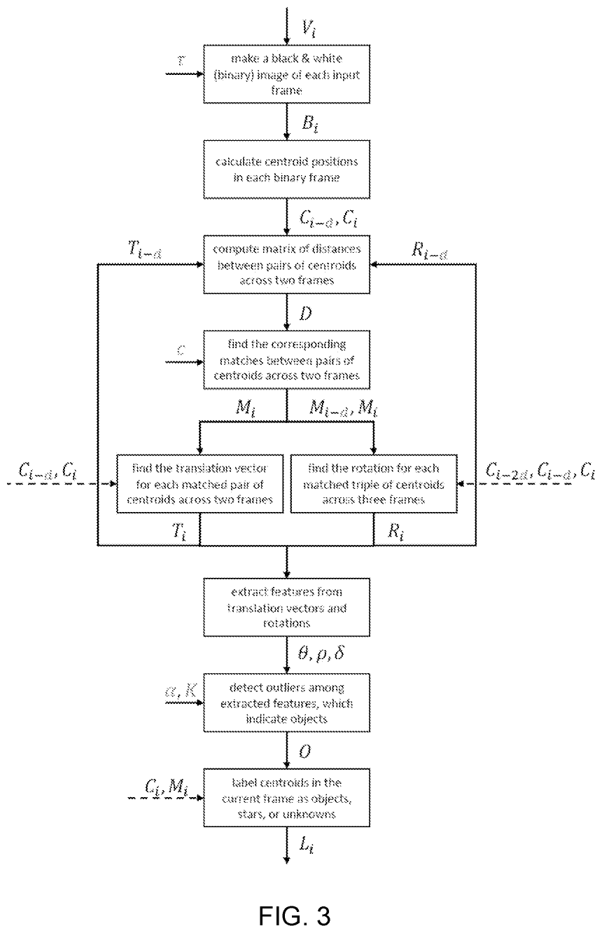

FIG. 3 illustrates a flow chart of the classification process with inputs denoted at each block. The input notations or input definitions for each block are defined below:
Vᵢ→i^{th} intensity/gray-scale video frame (in the block diagram, Vᵢ refers to the current frame, and V_{i_d} refers to the d^{th} frame before the current frame).
τ→Threshold value selected to make a black and white (binary) image from the intensity image.
Bᵢ→i^{th} black and white (binary) frame.
Cᵢ→Spot centroids for the i^{th} binary frame.
D→Distance matrix. Dp,q→Euclidean distance between the p^{th} spot centroid in the previous frame with q^{th} spot centroid of current frame c→Cost value selected for labeling a spot as ‘Unknown’ (no matching found).
Mᵢ→Matches contains (p, q) pairs such that p^{th} spot centroid in the previous frame is matched with the q^{th} spot centroid in the current frame.
Tᵢ→Translation vectors calculated for the i^{th} frame. For each matched pair, there is a translation vector defined from the centroid in the previous frame to the matched centroid in the current frame.
Rᵢ→Rotations calculated for the i^{th} frame. For each matched triple in three consecutive frames, there is a rotation defined from the centroid in the previous frame to the matched centroid in the current frame.
[θ, [symbol] , δ]→Translation directions θ, translation magnitudes [symbol] , and distance from median of center of rotations & are extracted classification features.
O→Outliers is a logical array whose elements are true when an outlier is detected in the corresponding extracted features.
a→Significance level is the probability of the study rejecting the null hypothesis, given that the null hypothesis is true.
K→Maximum outlier count specifies the maximum number (upper bound) of outliers returned by the method.
Lᵢ→Label of the spots in the i^{th} frame. Each label could be ‘Object’, ‘Star’, or ‘Unknown’.

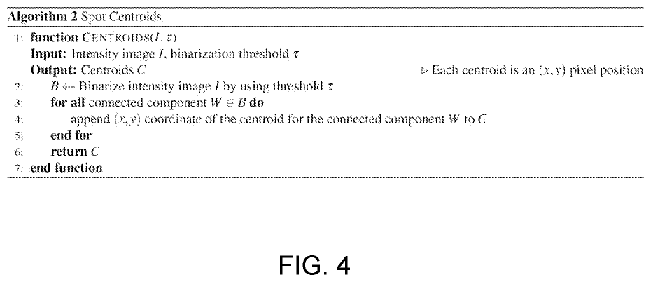

To determine the centroid of each spot using the detected white pixels, we find clusters of white pixels that are within one of the 8-connectivity neighborhoods of each other (e.g., in a 5×5 kernel). Each cluster can represent a set of connected components specifying an area in the image that each spot covers. A spot is then identified by the center of its corresponding connected components, denoted as a centroid. The centroids' information is calculated for each frame as illustrated by FIG. 4.

The classification algorithm uses the centroids' information at a given frame (referred to as current frame) as well as that of the centroid in the d-th frame before (referred to as previous frame), where d represents the history of the centroids' information that the process uses for computations.

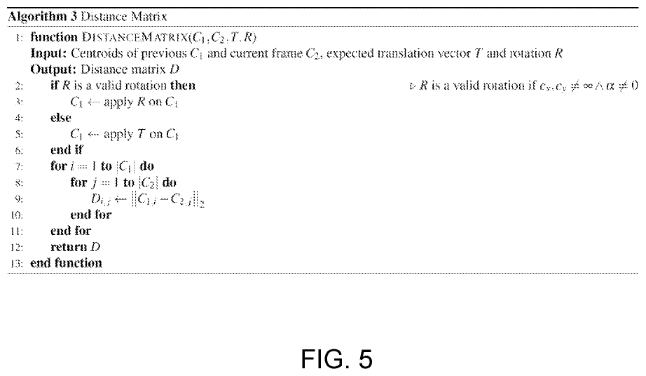

The distance of each center location of spots in the current frame as compared to those in the previous frame is calculated, as illustrated in FIG. 5. The history of motion of the spots can be used to calculate the distance matrix, since this distance information helps to find more accurate correspondences in the next step. This analysis generates a distance matrix whose entries evaluate the Euclidean distance between one centroid in the current frame to another one in the previous frame. The distance values represent the cost associated with matching two centroids between the current and previous frame.

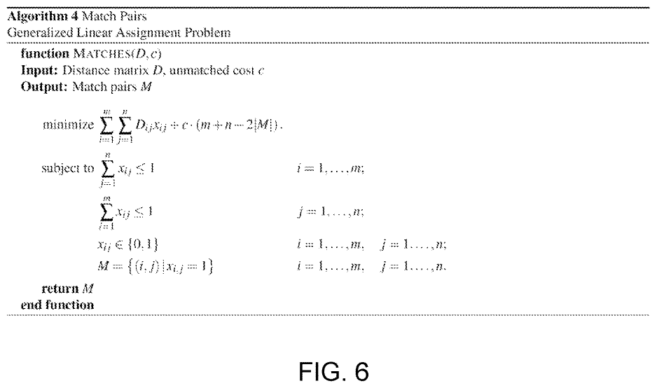

Using the distance matrix, the correspondence or matching between centroids in the current frame versus those in the previous frame can be obtained as illustrated in the pseudo code of the process 4 in FIG. 6. These correspondences can be one-to-one, i.e., each centroid in the current frame corresponds to one and only one centroid at maximum in the previous frame. Equivalently, each centroid in the previous frame can also have a maximum of one matched centroid in the current frame. Those centroids in the current frame for which a match cannot be found, for example in the case that a spot has just entered the image frame and was not present in the previous frame, are labeled as unknowns in that frame.

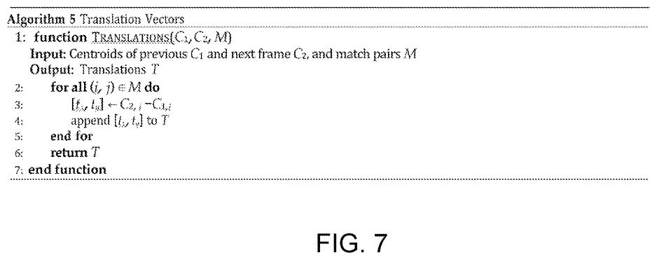

Using the matched pairs, a translation vector can be calculated for each centroid in the current frame relative to its corresponding matched centroid in the previous frame, as in process 5 of FIG. 7. Each translation vector can represent a shift in the location of a centroid from the previous frame to the current frame.

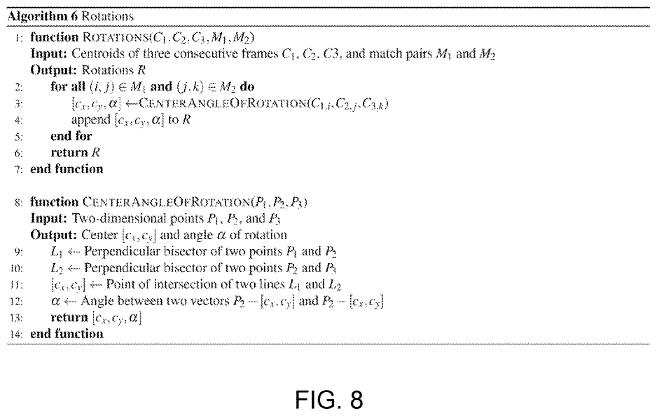

For each triplet of matched centroids in three consecutive frames, a rotation can be defined using a circle construction through three noncollinear points, also known as the circumscribed circle of a triangle defined by those three matched points, as in process 6 in FIG. 8. This rotation determines the trajectory along which a centroid rotates from the previous frame to the current frame.

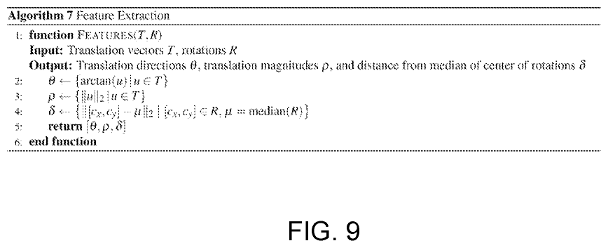

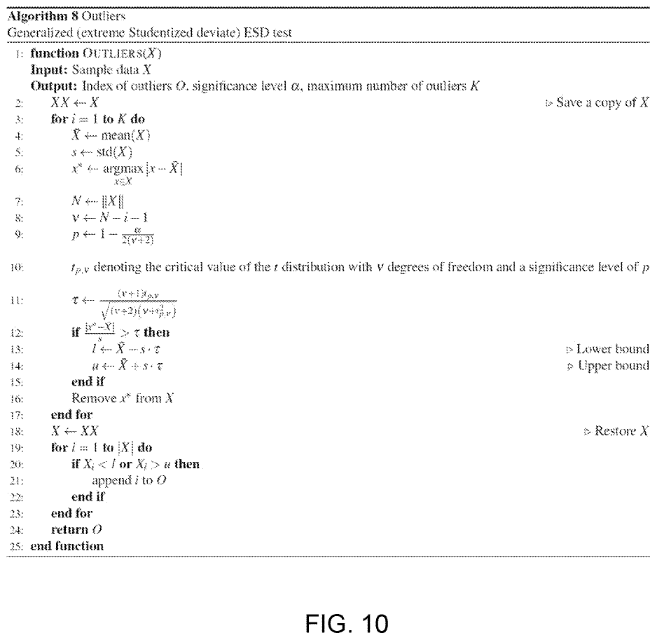

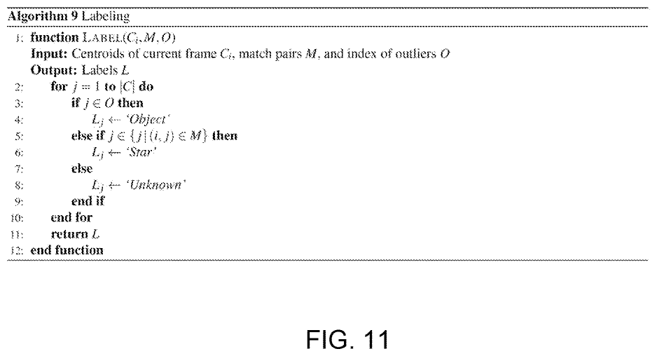

Process 7 in FIG. 9 illustrates the extraction of three classification features, including the direction and magnitude of translation vectors as well as the distance from the median of the center of rotations. Using a hypothesis testing approach, spot centroids with statistically different translation vectors in magnitude or direction and a different distance from the median of the center of rotations are classified into the objects class and are labeled as in object. The remainder of the spots are classified and labeled as stars. The statistical test and the labeling procedure are described in processes 8 and 9, in FIGS. 10 and 11 respectively.

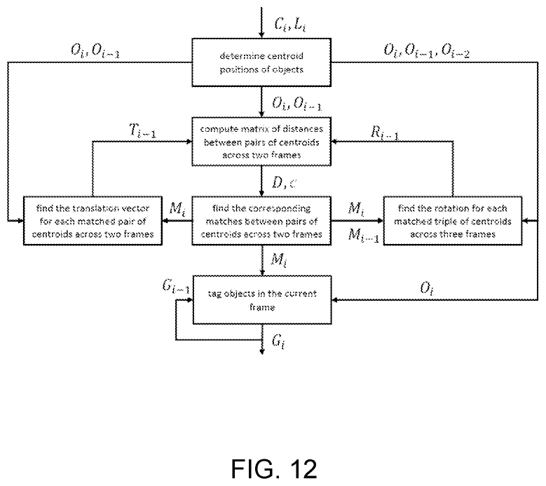

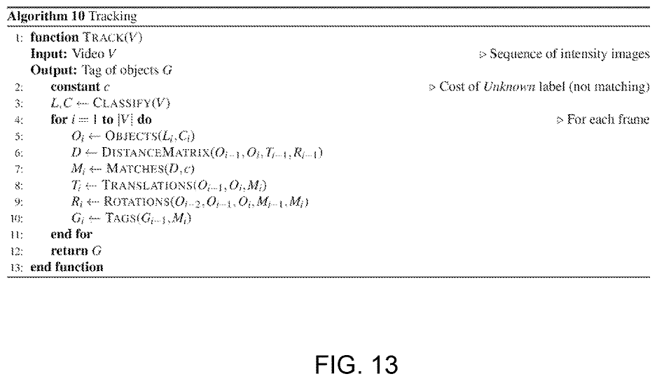

The purpose of the tracking process is to track the spots classified as objects in the classification step, across consecutive video frames. FIG. 12 and the process of FIG. 13 describe the computational methods and operations which may be used in the tracking process.

The block diagram input notations for FIG. 12 are defined below:
Cᵢ→Spot centroids for the ith frame.
Lᵢ→Label of the spots in the ith frame. Each label could be ‘Object’, ‘Star’, or ‘Unknown’.
Oᵢ→Object centroids for the ith frame.
D→Distance matrix. Dp,q→Euclidean distance between the p object centroid in the previous frame with q object centroid of current frame.
c→Cost value selected for no matching found.
Mᵢ→Matches contains (p, q) pairs such that p^{th} object centroid in the previous frame is matched with the q^{th} object centroid in the current frame.
Tᵢ→Translation vectors calculated for the i^{th} frame. For each matched pair, there is a translation vector defined from the object centroid in the previous frame to the matched object centroid in the current frame.
Rᵢ→Rotations calculated for the ith frame. For each matched triple in three consecutive frames, there is a rotation defined from the object centroid in the previous frame to the matched object centroid in the current frame.
Gᵢ→Tag of the objects in the i^{th} frame.

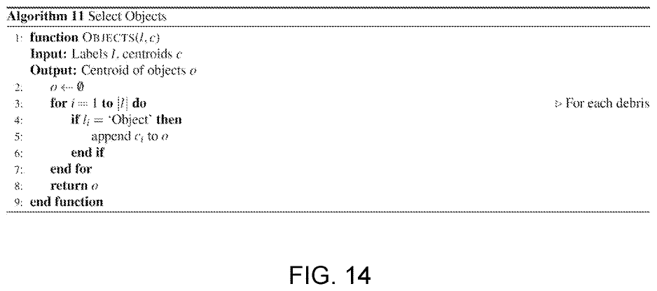

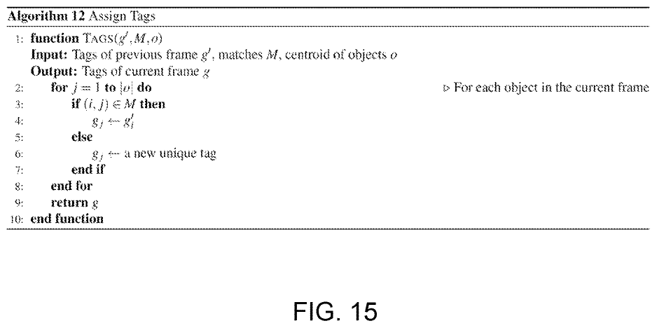

To track objects in each image frame, one operation is to determine the position of the objects in each frame. FIG. 14 illustrates that process 11 takes the centroids and labels of the spots obtained in the classification step, and returns the centroids of the spots labeled as objects, in this example. The distance matrix, object matches, translation vectors, and rotations used in process 10 may be calculated using the processes described respectively in processes 3, 4, 5, and 6 in the classification section. FIG. 15 with process 12 can generate a consistent tag for each object in a video frame based on the calculated matching and the tags generated in the previous frame.

The a priori information used by the system may include the estimated position of the camera (assuming the location will be known through GPS) and the estimated orientation and rotation rate of the spacecraft. The orientation of the camera can be close to but may not be exactly the same orientation of the spacecraft. In addition, the orientation may be determined through using a separate star tracker with a wider field of view, and the orientation of the camera system may vary based on differences between spacecraft. This is why the process can determine the location of the object relative to known stars in the camera field of view.

The process can use stars around magnitude 5 or 6 to limit the number of known stars used, which can make the process more efficient. The star tracker may have a narrow field of view camera for stars down to magnitude 9 or 10, which may detect stars on the order of a few hundred thousand, or down to magnitude 11 or 12 which will detect stars on the order of 1-2 million in number. A typical star tracker may use stars of magnitude 4-7, so the star tracker may have the information of 20,000 stars on board, but that can be increased with more efficient processing methods.

In one example, the camera used for the present technology may be a very low light camera, so the camera may be able to detect stars and objects down to star magnitude 11 or 12. The camera may be connected to a National Instruments 1473 FPGA board for the image processing, for instance. The camera may be a NightVista® M611-05 Low Light Level camera, for example, where the software is preferably efficient enough to run at a 60 Hz camera rate.

These processes may be designed to use a night vision camera on a spacecraft to detect resident space objects (RSOs) in earth orbit. The equipment assumed to be on the spacecraft is at least: a camera, a Global Positioning System (GPS), an Inertial Measurement Unit (IMU) and/or a separate star tracker.

A separate star tracker may be used due to the camera having a narrow field of view. The spacecraft may have a separate star tracker which may be used for attitude determination. The nominal angle between the camera and the star tracker may be known, however this information may not provide enough accuracy to be used directly due to uncertainties and variations in the angle. Instead this star tracker may be used in addition to the stars seen by the camera to update the camera attitude.

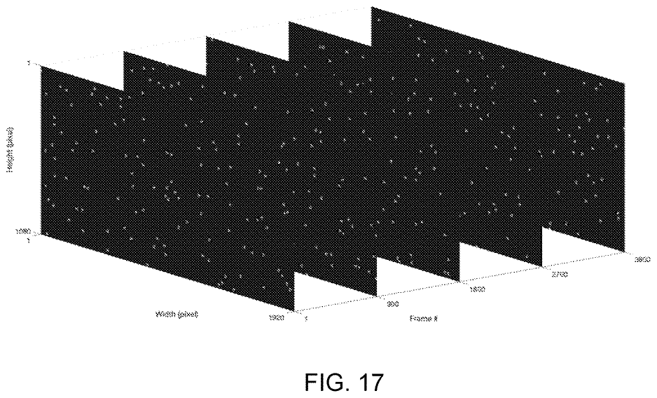

Sample video stills of a star field are illustrated in FIG. 17. These images provide an example idea of what the camera may observe. In one configuration, the information about the centroid locations/magnitudes of observed stars/objects at each frame can be used instead of the full video, and the implementation in the FPGA/camera may determine this information for each frame.

It is possible that the process may determine that some objects in the image are debris due to increased brightness. However, if an object is the same brightness as the stars in the image, the objects cannot be differentiated from the stars and may need a detection operation. The process can: use the detected centroid and brightness level of every spot in the camera FOV (stars and RSO), determine the orientation of the camera using the stars, determine which of the spots are RSO, and determine the absolute orientation to each RSO. The process can also use the change in brightness level of the RSO as well as how the RSO is moving relative to the camera to potentially estimate the orbital elements of the RSO. An actual camera is generally only able to get the centroid location of each spot detected and the brightness level.

The process(es) may receive certain inputs in order to identify RSOs. The inputs may be: the spacecraft position (from GPS), a time in seconds (from GPS), a spacecraft attitude (from a separate star tracker), a rotation rate (from an IMU and/or the separate star tracker), known star information down to a defined magnitude, the centroid positions of seen stars or objects, and/or the brightness intensity of each centroid in either star magnitude or photon flux.

The possible output of the processes may include: objects seen by the camera, camera attitude (can be the star tracker attitude±a delta), or objects estimated position relative to spacecraft. Further, information can be provided about the objects position, rotation, translation and speed, as possible additional output of the method. The seen position of each of the objects in both the earth frame and camera frame, as well as the photon flux can also be reported. X and Y pixel values in the data may represent the location of the centroid and have sub-pixel level accuracy.

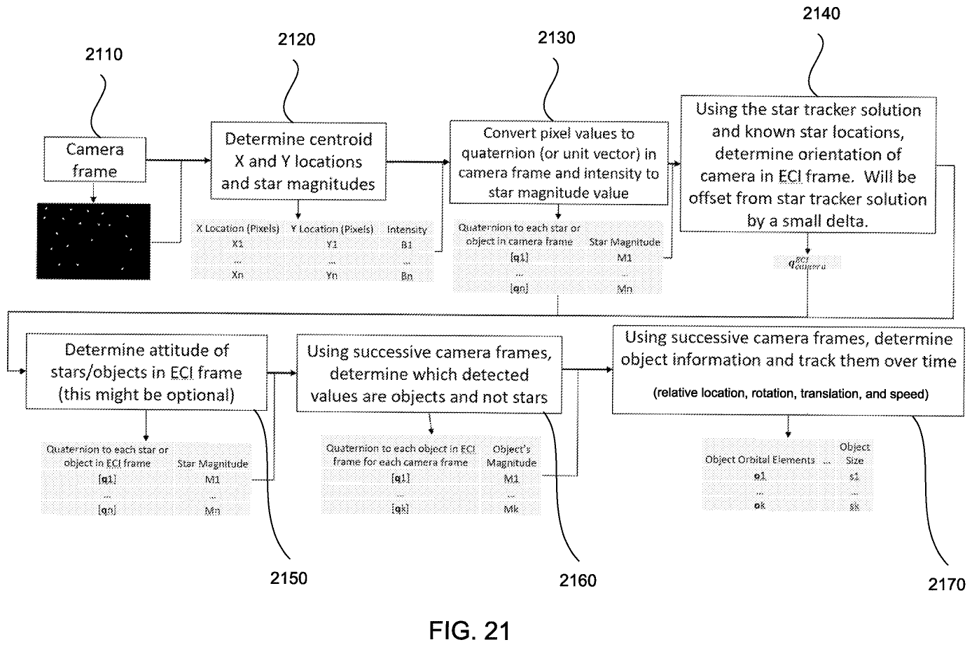

FIG. 21 illustrates another example of the method that can be performed to identify objects. In one optional configuration, these operations may be written to control a FPGA card that can connect to a camera. The method may include reading in the camera frame, as in block 2110. The centroid location of each star or object in the frame can then be determined, as in block 2120. The pixel value may be converted to a quaternion or unit vector, and the brightness intensity level may be converted to star magnitude level (this may include calibration to a screen if viewing is desired), as in block 2130.

The orientation of the camera in the frame may also be determined using the star tracker system and known star locations, as in block 2140. This orientation may be offset from the star tracker solution by a small delta (e.g., equal to the physical space between the camera and the star tracker). Optionally, the attitude of the stars and/or objects in the frame may be determined, as in block 2150. This camera coordinate frames can be directly and thus may not require conversion to the Earth-centered inertial (ECI) coordinate frames.

Before the debris can be tracked, the debris can first be identified and classified. The purpose of the classification process is to identify the bright spots in captured video sequences and to classify them as “objects” (representing orbital debris objects) or “stars”. In cases where the process is not able to classify detected spots into one of the object or star classes, that spot will be labeled as “unknown”, which is neither the object class nor the star class. Using successive camera frames, the detected values which are: stars, objects, or noise can be determined, as in block 2160. Using successive camera frames, the object information relative to the camera frame of reference can be determined and the objects can be tracked over time, as in block 2170. The outcome of the tracking may be used to track other object's variables such as a relative location, translation, speed, rotation rate, etc.

The classification method for segregating objects vs stars in each frame may also be used to compute the movement history of individual spots using a matching process. The movement information can be incorporated into an enhanced estimation of a spot's updated position in the upcoming frame. This procedure can reduce the number of not matched spots (unknown labels) across frames and increase the computational efficiency of the whole classification algorithm. Thus, the classification algorithm can include (1) performing detection, classification, matching and tagging for multiple objects moving in various directions and with various speeds, and (2) tracking objects with complicated motion and scene statistics across frames.

The tracking method (identifying and tracking a same object across frames) can handle the occlusion instances as well as the frame-by-frame variability in the total number of spots as they move in and out of a frame in order to add robustness and consistency to the tagging process of the detected and tracked objects. The classification process can handle variable angular rates of rotation for the spacecraft for the same set of objects and the process performs robustly to different spacecraft rotation rates.

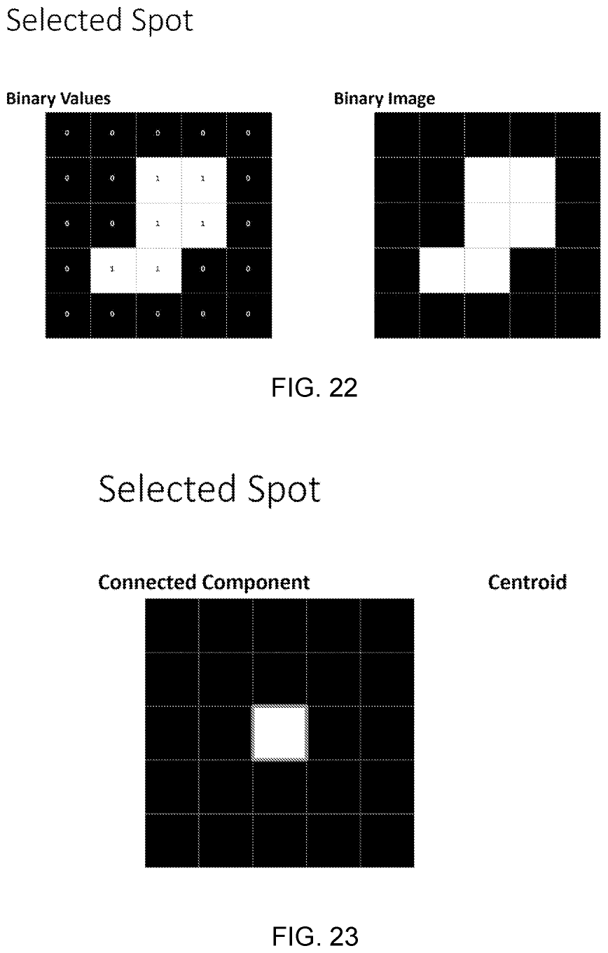

An input image may be specified as a 2-D grayscale image. The procedure expects pixel values of floating point data type to be in the range [0, 1]. FIG. 22 illustrates that a process can binarize image I using threshold τ. τ is a global image threshold, specified as a scalar luminance value. τ is defined to have values between 0 and 1. The output binary image can be returned as a logical matrix or logical array of the same size as I. A global intensity threshold value can be chosen such that the threshold can remove or filter out as many noisy pixels as possible in the input frames. Using this threshold value, input grayscale images are converted into binary black and white images.

FIG. 23 illustrates that to determine the centroid of each spot using the detected white pixels, a connected component marking an area is found in the image that each spot covers. Each spot is then identified by the center of its corresponding connected components (e.g., centroids).

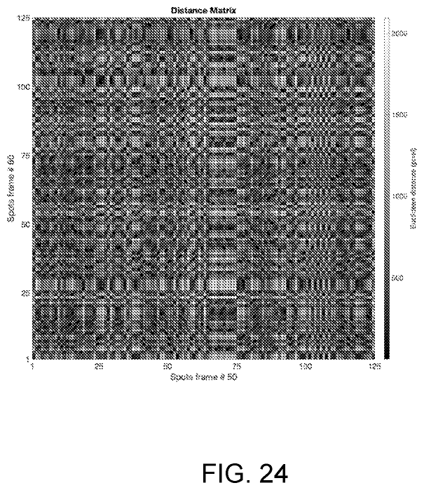

As discussed earlier, a distance matrix can then be calculated for two successive frames. FIG. 24 illustrates an example distance matrix. The entries of the distance matrix represent a cost associated with matching two centroids between the current and previous frames. This process uses the history of motion of the spots to calculate the distance matrix since this information helps to find more accurate correspondences in the next step. The distance matrix can handle more complex movement patterns of objects and stars and can provide information used as the input to the tracking process. A Euclidean distance matrix can be a square matrix (two-dimensional array) containing the Euclidean distances, taken pairwise, between the spots of two consecutive frames.

Using the distance matrix, a correspondence is obtained between centroids in the current frame versus those in the previous frame. These correspondences are one-to-one, i.e., each centroid in the current frame corresponds to one and only one centroid at maximum in the previous frame. Equivalently, each centroid in the previous frame can also have a maximum of one matched centroid in the current frame. Those centroids in the current frame for which a match cannot be found, for example in the case that a spot has just entered the image frame and was not present in the previous frame, are labeled as unknowns in that frame.

Finding matchings for centroids between the current frame and previous frame can be performed by solving the linear assignment problem for the rows and columns of the distance matrix. Each row can be assigned to a column in such a way that the total cost is minimized. Unmatched cost (c) specifies the cost per row of not assigning each row and also the cost per column of not having a row assigned to each column. The linear assignment problem is a way of assigning rows to columns such that each row is assigned to a column and the total cost of the assignments is minimized. The cost of assigning each row to each column is captured in a distance matrix. The entry D(i, j) is the cost of assigning row i to column j. The cost of unassignment assigns a cost to any row or column that is not matched. This practice allows for minimum-cost solutions that do not assign all rows or columns. If a row and column are not matched, this increases the total cost by 2×c.

Using the matched pairs, a translation vector can be calculated for each centroid in the current frame relative to the corresponding matched centroid in the previous. Each translation vector represents a shift in the location of a centroid from the previous frame to the current frame.

Rᵢ represents rotations calculated for the i^{th} frame. A circle can be defined with three points. Defining and measuring the rotation pattern of spots include analyzing more than two consecutive frames. For each triplet of matched centroids in three consecutive frames, a rotation can be defined using a circle construction through three noncollinear points, also known as the circumscribed circle of a triangle defined by those three matched points (See also process 6 in FIG. 8). This rotation can determine the trajectory along which a centroid rotates from the previous frame to the current frame.

Translation directions θ, translation magnitudes ρ, and distance from the median of the center of rotations δ can be extracted classification features. The rotation measurement can enable a successful matching, and can also be used as a feature for detecting objects via the statistical hypothesis testing method.

Using a hypothesis testing approach, spot centroids with statistically different translation vectors in magnitude or direction or different center of rotations are determined to be outliers. The extraction of rotation information in the classification process, not only improves the performance of the classification operation but also enables handling the complexities of the statistics of the videos captured in real-world settings.

The generalized extreme Studentized deviate test can be applied to find outliers. The generalized (extreme Studentized deviate) ESD test is used to detect one or more outliers in a univariate data set that follows an approximately normal distribution. By comparison, the primary limitation of the Grubbs test and the Tietjen-Moore test is that the suspected number of outliers, K, can be specified exactly. If K is not specified correctly, this can distort the conclusions of these comparison tests. On the other hand, the generalized ESD test uses only an upper bound for the suspected number of outliers be specified.

Labeling can then occur. The outlier spots can be classified into the objects class and the remainder of the spots can be classified as stars. As mentioned before, those centroids for which a match cannot be found can be labeled as unknowns.

Tracking may then occur. Centroids and their labels can be obtained in a certain frame and the centroid positions of objects in that frame can also be determined. In the first frame, the detected objects can be tagged arbitrarily. Now suppose that new objects appear in the new frame. Matching may then occur. The output of the matching algorithm (as described in the classification step) can then be obtained. A first object may be assigned to the closest object in the next frame.

The distance matrix, matches, translation vectors, and rotations used in tracking (See process 10 in FIGS. 12 and 13) are calculated using the processes described respectively in process 3, 4, 5, and 6 in the classification section.

Extraction of rotation information can contribute not only to the classification results, but more importantly can enable correct matching and tagging as two meaningful components of tracking. A correct matching across frames is useful in capturing a consistent and precise trajectory of individual objects independent of their motion pattern.

The last function in each iteration can be tagging the objects. Based on the matching step, a first object can get the label of number one and a second object which is a new object can get the label number two. Suppose both objects start moving in the new frame. Again, the matching step finds the correspondences. And in the tagging step, the labels which are compatible with the previous frame, will be assigned to the objects of the current frame.

Now suppose that some objects disappear in the new frame for any reason. Again, the matching step and the labeling steps can be repeated. If new objects appear again in the next frame, then the matching and labeling steps can be repeated. In the tagging step, new objects can be labeled with new tags and the process will not check to see if the objects have been seen before. Thus, the matching and tagging can be repeated as needed.

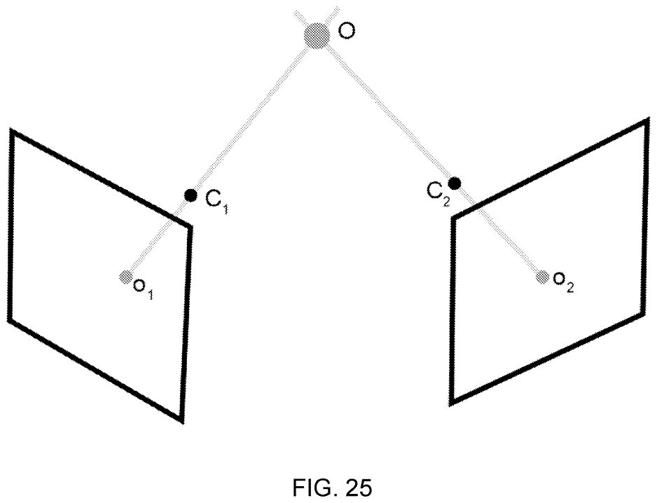

In one configuration of the technology, the actual location of the objects in 3D space can be determined. Using successive camera frames, object information regarding the relative location, orbital elements, rotation rate, size of objects, etc. can be determined. To achieve this goal, the objects can be tracked in at least two consecutive frames consistently. From a single image, it is difficult to reconstruct a 3D scene. If two images are available, then the position of a 3D point can be found as the intersection of the two projection rays, as illustrated in FIG. 25. This process is generally referred to as triangulation. FIG. 25 illustrates the ideal case of epipolar geometry. A 3D point O is projected onto two camera images through lines which intersect with the camera's center at two consecutive frames, C₁ and C₂. The resulting image points are o₁ and o₂. The lines intersect at O. Based on the triangulation process, having two frames is sufficient to find the depth of objects in the 3D space. Using this geometrical approach, the results of the present vision-based tracking process may be used for 3D reconstruction and tracking of objects imaged by a constellation of satellites.

The present technology uses a statistical classifier and tracking process to detect, classify and track small bright spots in the input image sequence. When applied to the simulated videos of small orbital debris objects moving over a static or dynamic star background, the present processes were able to robustly detect, classify and track the objects versus stars.

The proposed processes have several degrees of freedom (DoF) which can affect the classification and tracking performance such as: cost of unknown labels, delay between two consecutive frames, threshold of binarization parameter, significance level parameter, and maximum possible number of outliers. These degrees of freedom may be adjusted to improve the performance of the technology. More specifically, the DoFs can be optimized based on certain applications or desired performance measures.

Another example of the technology using sample data will now be described. In a sample data set, the sample video frame size may be 1080 height×1920 width in pixels, frame rate can be 60 frames per second (fps), video duration can be 60 seconds, color format can be grayscale, and the source data type can be a floating-point number between 0 and 1. Using grayscale images as the input, each pixel value between 0 and 1 in the image can represent the light intensity at that pixel, with larger values representing brighter pixels (or an inverse value range may be used).

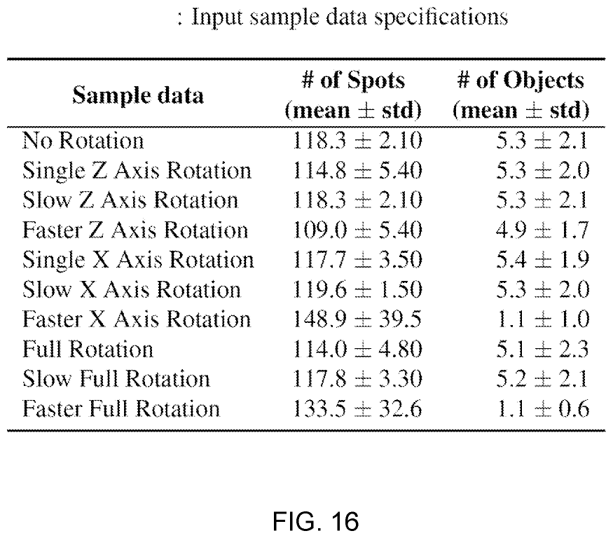

Ten different datasets have been used to evaluate the performance of the classification and tracking algorithms. These particular datasets were provided by NASA. Each of these datasets may have different complexities in the characteristics of their foreground (number of objects and their motion pattern) and background (stars motion pattern). The title of each dataset in FIG. 16 indicates the status of the spacecraft when capturing the video frames. Information about tested sets of sample data is summarized in FIG. 16.

An illustration of how the sample data appears is illustrated in FIG. 17. The sample data is a sequence of grayscale intensity image frames over time, and FIG. 17 represents a few snapshots of the captured video sequence. Sample snapshots of one of the sample video files are shown in FIG. 17.

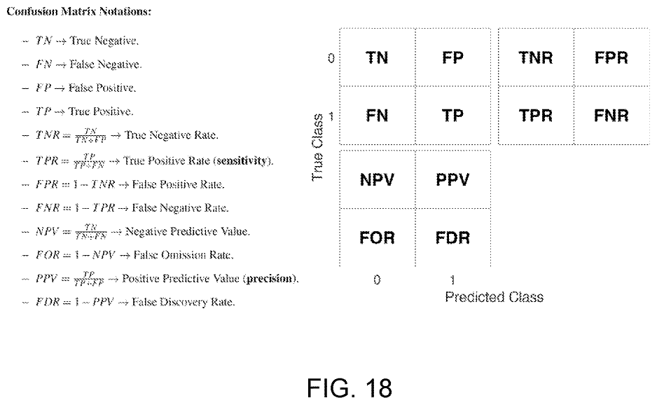

The performance of the classification algorithm is measured using a confusion matrix whose rows and columns indicate, respectively, the actual labels for the spots from the ground truth data (True Class) and those predicted by the classification algorithm (Predicted Class) in FIG. 18.

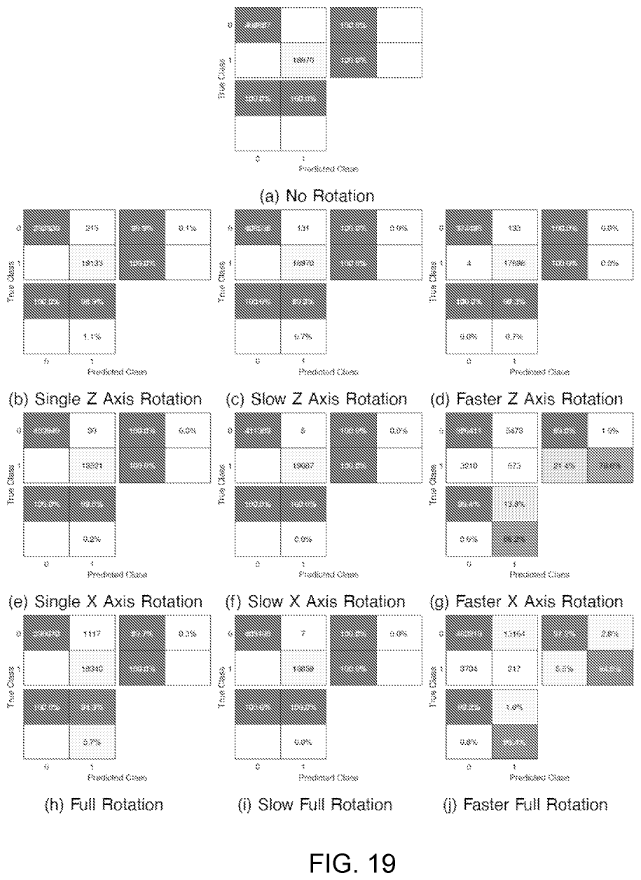

FIG. 19 summarizes the results of applying the classification algorithm on each of the datasets listed in FIG. 16, which report various performance measures described in FIG. 18. FIG. 19 illustrates confusion matrices obtained by running the classification algorithm on a few sample input videos from FIG. 16. Here the spots classified as unknowns by the classification algorithm were manually included in the objects class in order to be able to define only two classes for calculating the confusion matrix.

Two measures that are useful for analyzing the performance of the classifier for the orbital debris classification application include: 1) sensitivity—the ratio of the number of spots correctly classified as an object to the total number of objects across all video frames, and 2) precision—the ratio of the number of spots correctly classified as an object to the total number of spots classified as objects across all video frames. The results show that the classification process performed more accurately in both sensitivity and precision senses on the sample datasets with more realistic motion patterns (denoted by ‘slow rotation’), and was less accurate in discriminating between objects and stars in the datasets denoted by ‘faster rotation’, which use unrealistic moving speeds compared to what is expected from the captured videos in real-world settings.

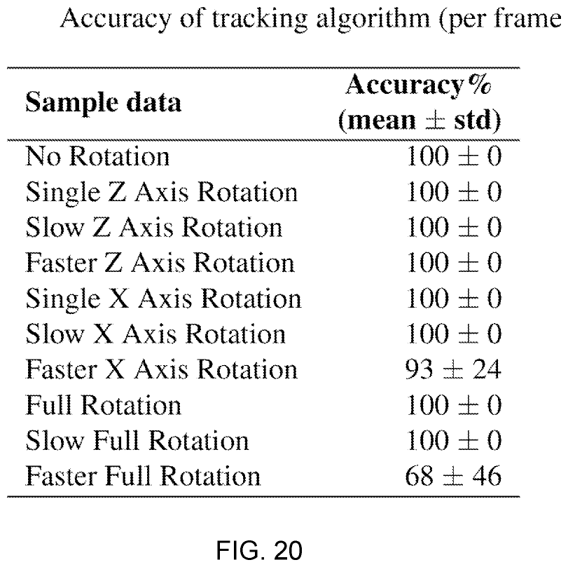

The accuracy of the tracking algorithm can be defined as the ratio of the number of correctly tracked objects to the total number of correctly identified objects per frame. FIG. 20 illustrates the reported performance of the tracking process, measured as the average accuracy across all the frames in the input video data for all the sample datasets described in FIG. 16. The results illustrated in FIG. 20 are similar to the classification performance results, and except for the ‘Faster Z Axis Rotation’ and ‘Faster X Axis Rotation’ datasets (with unrealistically high speed simulated spacecraft motion) the tracking algorithm performed accurately across the sample datasets.

For this example analysis, the values of unmatched cost (c), delay between two consecutive frames (d), significance level parameter (α), and the maximum possible number of outliers (K) used for detecting the outliers were set respectively to 1000, 1, 0.05 and 10% of the total number of spots in the current frame.

In this technology, classifier (e.g., statistical classifier) and tracking processes are used to classify and track small bright spots in an input image sequence. When applied to simulated videos of small orbital debris objects moving over a static or dynamic star background, the processes were successful in robustly classifying objects versus stars and consistently tracking the detected objects in consecutive frames.

The classifier may have several degrees of freedom which can affect the classification and tracking performance. Two of those degrees of freedom (DoF) are: cost of unknown labels (c) and delay between two consecutive frames (d). For other DoF, values were chosen such that the processes showed the best performance on the sample data under study. However, these DoF can be tuned and optimized based on the statistics of the input images to be able to generalize to a variety of image settings or complexities. For example, for the threshold of binarization parameter (τ), a constant global value was selected here, but other dynamic thresholding methods could be used to adapt this value to any particular input image statistics. In addition, the significance level parameter (α) and the maximum possible number of outliers (K) parameter used for detecting outliers are also among the DoF of the algorithm. The possible DoF values can be optimized based on specific applications and the desired performance measures.

Moreover, the features used in process 7 of FIG. 9 were extracted based on the motion model of stars and objects that described the sample datasets under study. These features can be modified or other possible features may be used based on the particular characteristics and the motion models that describe a model's data. There are also a variety of methods for video tracking (e.g., the process of locating one or multiple moving objects over time) such as mean-shift tracking, Kalman filter, and Particle filter. These methods analyze sequential video frames and output the movement trajectory of objects of interest between the frames. This technology may use any of these or other tracking algorithms depending on particular characteristics of the data at hand.

One example application of this technology is expanding the network of space sensors to provide accurate, specialized catalogues for assessing collision risk in real time. Conjunction analysis may be performed continuously, and the sensor network may allow timely collision prediction in real time. This space tracking and debris monitoring technology provides high performance in space catalogue acquisition and maintenance. Some performance indicators provided by the present technology are:
Accuracy. Space object position can be determined with an accuracy as high as the resolution of the camera. No other operational space technology currently offers this accuracy.
Sensitivity. Trackers have been validated for tracking multiple objects moving in various directions, and across ranges of speed, rotation, background complexities, and occlusion conditions. This sensitivity to variety of motion features and conditions provides a reliable solution to address collision risk to operational spacecrafts.
Range. Since the tracker uses images captured by the cameras mounted on spacecrafts or satellites, sensors are able to readily track all orbit heights and regimes from low Earth orbit (LEO) through to geosynchronous equatorial orbit (GEO) and beyond.
Cost. Low cost per space track allows frequent tracking of each object and highly accurate catalogs.

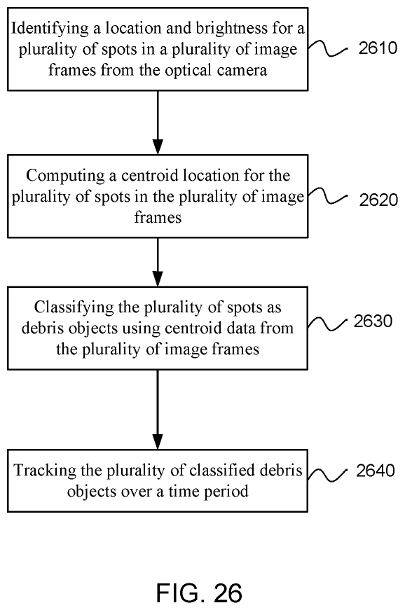

To summarize and reiterate regarding the technology, FIG. 26 is a flow chart illustrating a brief summary of classifying and tracking orbital debris objects using an optical camera. One operation may be identifying a location and brightness for a plurality of spots in a plurality of image frames from the optical camera, as in block 2610. The images or image frames may be grayscale images that are converted to black and white images to enable determining of the position of the plurality of spots in each frame. The area of each spot may be detected using white pixels and finding clusters of white pixels that are within one of 8 connectivity neighbors of each other.

Another operation may be computing a centroid location for the plurality of spots in the plurality of image frames, as in block 2620. The computing of the centroids may include using centroids of a given frame and centroids of one or more previous frames.

The distances of center locations of spots in a current frame as compared to spots in the previous frame can be calculated, and the distances can represent the cost associated with matching two centroids between the current and previous frame. A correspondence may be obtained between centroids in the current frame and the previous frame. In addition, a translation vector for each centroid in the current frame relative to its corresponding matched centroid in the previous frame may be calculated.

A rotation for matched centroids using a circle construction through three non-collinear points can be computed.

The plurality of spots can be classified as debris objects or stars using centroid data from the plurality of image frames, as in block 2630. The classification of the plurality of spots as debris objects can be performed using a statistical test for differentiating between stars and debris objects in the plurality of spots detected. Centroids with statistically different translation vectors in magnitude or direction and/or a different distance from the median of the center of rotations may be classified into the object class. In one configuration, the statistical test can be the extreme Studentized deviate test. In one example, an outlier that would pass the test would have a statistical significance threshold of 5%. This classification process may be considered a statistical approach in a non-parametric domain. In addition, using this statistical method is efficient computationally and inexpensive. Other types of non-parametric or parametric statistics that may also be used to reject a null hypothesis.

In alternative configurations, other types of parametric approaches or machine learning may be used to classify the plurality of spots or points as debris objects or stars. The classifying process for the plurality of spots can take successive camera frames as input and determine which detected values are debris objects. In addition, any of the features described earlier may be used as feature inputs for a machine learning classifier for this process. If there are multiple satellites imaging the same space then this may provide additional or high dimensionality features for use with the machine learning. For example, the machine learning used for the classification operation may use at least one of: supervised machine learning, unsupervised machine learning, a neural network, outlier detection, anomaly detection, K-means clustering, density-based approaches, logistic regression, etc. Spots which do not have a centroid match in a previous frame may be classified as unknown.

The object debris or stars identified during classification or upon completion of classification can be tagged or labeled. The plurality of classified debris objects may then be tracked over a time period, as in block 2640. The tracking may further include locating classified debris objects in consecutive frames and tracking the debris objects.

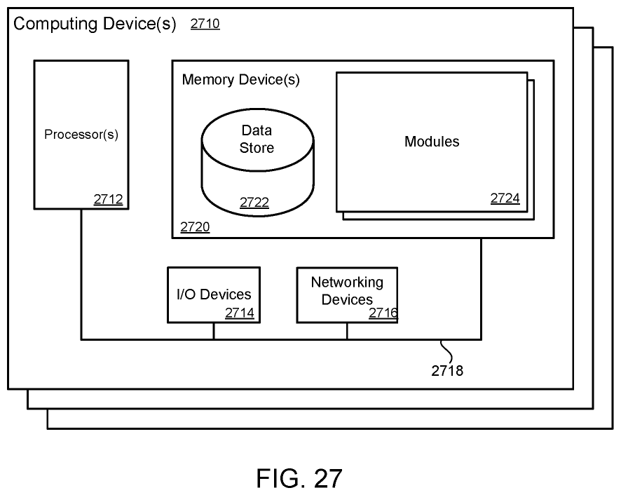

FIG. 27 illustrates a computing device 2710 which may execute the foregoing subsystems of this technology. The computing device 2710 and the components of the computing device 2710 described herein may correspond to the servers and/or client devices described above. The computing device 2710 is illustrated on which a high-level example of the technology may be executed. The computing device 2710 may include one or more processors 2712 that are in communication with memory devices 2720. The computing device may include a local communication interface 2718 for the components in the computing device. For example, the local communication interface may be a local data bus and/or any related address or control busses as may be desired.

The memory device 2720 may contain modules 2724 that are executable by the processor(s) 2712 and data for the modules 2724. For example, the memory device 2720 may include a classification module, a tracking module, and other modules. The modules 2724 may execute the functions described earlier. A data store 2722 may also be located in the memory device 2720 for storing data related to the modules 2724 and other applications along with an operating system that is executable by the processor(s) 2712.

Other applications may also be stored in the memory device 2720 and may be executable by the processor(s) 2712. Components or modules discussed in this description that may be implemented in the form of software using high programming level languages that are compiled, interpreted or executed using a hybrid of the methods.

The computing device may also have access to I/O (input/output) devices 2714 that are usable by the computing devices. An example of an I/O device is a display screen that is available to display output from the computing devices. Other known I/O device may be used with the computing device as desired. Networking devices 2716 and similar communication devices may be included in the computing device. The networking devices 2716 may be wired or wireless networking devices that connect to the internet, a LAN, WAN, or other computing network.

The components or modules that are shown as being stored in the memory device 2720 may be executed by the processor 2712. The term “executable” may mean a program file that is in a form that may be executed by a processor 2712. For example, a program in a higher-level language may be compiled into machine code in a format that may be loaded into a random-access portion of the memory device 2720 and executed by the processor 2712, or source code may be loaded by another executable program and interpreted to generate instructions in a random-access portion of the memory to be executed by a processor. The executable program may be stored in any portion or component of the memory device 2720. For example, the memory device 2720 may be random access memory (RAM), read only memory (ROM), flash memory, a solid-state drive, memory card, a hard drive, optical disk, floppy disk, magnetic tape, or any other memory components.

The processor 2712 may represent multiple processors and the memory device 2720 may represent multiple memory units that operate in parallel to the processing circuits. This may provide parallel processing channels for the processes and data in the system. The local interface 2718 may be used as a network to facilitate communication between any of the multiple processors and multiple memories. The local interface 2718 may use additional systems designed for coordinating communication such as load balancing, bulk data transfer, and similar systems.

### CLAUSES

For purposes of clarity, additional variations of the method can include:

Clause 1. A method for classifying and tracking orbital debris objects using an optical camera, comprising:
a. identifying a location and brightness for a plurality of spots in a plurality of image frames from the optical camera;
b. computing a centroid location for the plurality of spots in the plurality of image frames;
c. classifying the plurality of spots as debris objects or stars using centroid data from the plurality of image frames to produce a plurality of classified debris objects; and
d. tracking the plurality of classified debris objects over time.

Clause 2. The method as in any clause, wherein classifying the plurality of spots as debris objects is performed using a statistical test for differentiating between stars and debris objects in the plurality of spots detected.

Clause 3. The method as in any clause, wherein the statistical test is an extreme Studentized deviate test.

Clause 4. The method as in any clause, wherein classifying the plurality of spots as debris objects can be extended to be performed using at least one of: supervised machine learning, unsupervised machine learning, a neural network, K-means clustering, or regression.

Clause 5. The method as in any clause, further comprising classifying centroids with statistically different translation vectors in magnitude or direction and a different distance from a median of a center of rotations into an object class.

Clause 6. The method as in any clause, wherein classifying the plurality of spots takes successive camera frames as input and determines which detected values are debris objects.

Clause 7. The method as in any clause, further comprising tagging of the debris objects or stars identified during classification.

Clause 8. The method as in any clause, wherein the tracking further comprises locating classified debris objects in consecutive frames and tracking the debris objects over time.

Clause 9. The method as in any clause, further comprising converting input grayscale images to black and white images to enable determining a position of the plurality of spots in each frame.

Clause 10. The method as in clause 9, further comprising determining an area of each spot using detected white pixels and finding clusters of white pixels that are within one of 8 connectivity neighbors of each other.

Clause 11. The method as in any clause, wherein computing the centroid location further comprises using centroids of a given frame and centroids of one or more previous frames.

Clause 12. The method as in any clause, further comprising:
a. calculating distances of center locations of spots in a current frame as compared to spots in a previous frame, which represents a cost associated with matching two centroids between the current frame and the previous frame;
b. obtaining a correspondence between centroids in the current frame and the previous frame; and
c. calculating a translation vector for each centroid in the current frame relative to a corresponding matched centroid in the previous frame.

Clause 13. The method as in any clause, further comprising identifying a rotation for matched centroids using a circle construction through three non-collinear points.

Clause 14. The method as in any clause, further comprising classifying spots which do not have a centroid match in a previous frame as unknown.

Clause 15. The method as in any clause, further comprising tracking spots classified as objects across consecutive video frames by using centroids labeled as objects and using a distance matrix, object matches, translation vectors, and rotations to track objects' positions.

Clause 16. A system for tracking orbital debris objects using an optical camera, comprising:
at least one processor; and
a memory device including instructions that, when executed by the at least one processor, cause the system to:
a. identify a location and brightness for a plurality of spots in a plurality of image frames from the optical camera:
   b. compute a centroid location for the plurality of spots in the plurality of image frames;
c. classify the plurality of spots as debris objects using centroid data from the plurality of image frames to produce a plurality of classified debris objects; and
d. track the plurality of classified debris objects over a time period.

Clause 17. The system as in any clause, further comprising classifying the plurality of spots as debris objects is performed using a statistical test for differentiating between stars and debris objects in the plurality of spots detected.

Clause 18. The system as in clause 17, wherein the statistical test is an extreme Studentized deviate test.

Clause 19. A computer readable storage medium having instructions embodied thereon, the instructions when executed by one or more processors, cause the one or more processors to perform a process comprising:
a. identifying a location and brightness for a plurality of spots in a plurality of image frames from an optical camera;
b. computing a centroid location for the plurality of spots in the plurality of image frames;
c. classifying the plurality of spots as debris objects using centroid data from the plurality of image frames to produce a plurality of classified debris objects; and
d. tracking the plurality of classified debris objects over a time period.

Clause 20. The computer readable storage medium as in any clause, further comprising classifying the plurality of spots as debris objects is performed using a statistical test for differentiating between stars and debris objects in the plurality of spots detected.

Clause 21. The computer readable storage medium as in clause 20, wherein the statistical test is an extreme Studentized deviate test.

While the flowcharts presented for this technology may imply a specific order of execution, the order of execution may differ from what is illustrated. For example, the order of two more blocks may be rearranged relative to the order shown. Further, two or more blocks shown in succession may be executed in parallel or with partial parallelization. In some configurations, one or more blocks shown in the flow chart may be omitted or skipped. Any number of counters, state variables, warning semaphores, or messages might be added to the logical flow for purposes of enhanced utility, accounting, performance, measurement, troubleshooting or for similar reasons.

Some of the functional units described in this specification have been labeled as modules or processes, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more blocks of computer instructions, which may be organized as an object, procedure, or function. Nevertheless, the executables of an identified module need not be physically located together, but may comprise disparate instructions stored in different locations which comprise the module and achieve the stated purpose for the module when joined logically together.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices. The modules may be passive or active, including agents operable to perform desired functions.

The technology described here can also be stored on a computer readable storage medium that includes volatile and non-volatile, removable and non-removable media implemented with any technology for the storage of information such as computer readable instructions, data structures, program modules, or other data. Computer readable storage media include, but is not limited to, RAM, ROM, EEPROM, flash memory or other memory technology, CD-ROM, digital versatile disks (DVD) or other optical storage, magnetic cassettes, magnetic tapes, magnetic disk storage or other magnetic storage devices, or any other computer storage medium which can be used to store the desired information and described technology.

The devices described herein may also contain communication connections or networking apparatus and networking connections that allow the devices to communicate with other devices. Communication connections are an example of communication media. Communication media typically embodies computer readable instructions, data structures, program modules and other data in a modulated data signal such as a carrier wave or other transport mechanism and includes any information delivery media. A “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency, infrared, and other wireless media. The term computer readable media as used herein includes communication media.

Furthermore, the described features, structures, or characteristics may be combined in any suitable manner in one or more examples. In the preceding description, numerous specific details were provided, such as examples of various configurations to provide a thorough understanding of examples of the described technology. One skilled in the relevant art will recognize, however, that the technology can be practiced without one or more of the specific details, or with other methods, components, devices, etc. In other instances, well-known structures or operations are not shown or described in detail to avoid obscuring aspects of the technology.

Although the subject matter has been described in language specific to structural features and/or operations, it is to be understood that the subject matter defined in the appended claims is not necessarily limited to the specific features and operations described above. Rather, the specific features and acts described above are disclosed as example forms of implementing the claims. Numerous modifications and alternative arrangements can be devised without departing from the spirit and scope of the described technology.

1. A method for classifying and tracking orbital debris objects using an optical camera, comprising:
identifying a location and brightness for a plurality of spots in a plurality of image frames from the optical camera;
computing a centroid location for the plurality of spots in the plurality of image frames;
classifying the plurality of spots as debris objects or stars using centroid data from the plurality of image frames to produce a plurality of classified debris objects, by computing a matrix of distances between pairs of centroids across two frames and determining a corresponding matched centroid from among the pairs of centroids to produce a plurality of matched centroids across the two frames, calculating a translation vector for the plurality of matched centroids, and identifying a plurality of matched triplets across three frames from among the plurality of matched centroids, and calculating a rotation for the plurality of matched triplets; and
tracking the plurality of classified debris objects over time.

2. The method as in claim 1, wherein classifying the plurality of spots as debris objects is performed using a statistical test for differentiating between stars and debris objects in the plurality of spots detected.

3. The method as in claim 2, wherein the statistical test is an extreme Studentized deviate test.

4. The method as in claim 1, wherein classifying the plurality of spots as debris objects is extended to be performed using at least one of: supervised machine learning, unsupervised machine learning, a neural network, K-means clustering, or regression.

5. The method as in claim 1, further comprising classifying centroids with statistically different translation vectors in magnitude or direction and a different distance from a median of a center of rotations into an object class.

6. The method as in claim 1, wherein classifying the plurality of spots takes successive camera frames as input and determines which detected values are debris objects.

7. The method as in claim 1, further comprising tagging of the debris objects or stars identified during tracking of classified debris objects using the translation vector and the rotation.

8. The method as in claim 1, wherein the tracking further comprises locating classified debris objects in consecutive frames and tracking the debris objects over time.

9. The method as in claim 1, further comprising converting input grayscale images to black and white images to enable determining a position of the plurality of spots in each frame.

10. The method as in claim 9, further comprising determining an area of each spot using detected white pixels and finding clusters of white pixels that are within one of 8 connectivity neighbors of each other.

11. The method as in claim 1, wherein computing the centroid location further comprises using centroids of a given frame and centroids of one or more previous frames.

12. The method as in claim 1, wherein the computing the matrix of distances further comprises:
calculating distances of center locations of spots in a current frame as compared to spots in a previous frame, which represents a cost associated with matching two centroids between the current frame and the previous frame;
obtaining a correspondence between centroids in the current frame and the previous frame; and
calculating the translation vector for each centroid in the current frame relative to a corresponding matched centroid in the previous frame.

13. The method as in claim 1, further comprising identifying the rotation for matched triplets using a circle construction through three non-collinear points.

14. The method as in claim 1, further comprising classifying spots which do not have a centroid match in a previous frame as unknown.

15. The method as in claim 1, further comprising tracking spots classified as objects across consecutive video frames by using centroids labeled as objects and using a distance matrix, object matches, translation vectors, and rotations to track objects' positions.

16. A system for tracking orbital debris objects using an optical camera, comprising:
at least one processor; and
a memory device including instructions that, when executed by the at least one processor, cause the system to:
identify a location and brightness for a plurality of spots in a plurality of image frames from the optical camera;
compute a centroid location for the plurality of spots in the plurality of image frames;
classify the plurality of spots as debris objects using centroid data from the plurality of image frames to produce a plurality of classified debris objects, by computing a matrix of distances between pairs of centroids across two frames and determining a corresponding matched centroid from among the pairs of centroids to produce a plurality of matched centroids across the two frames, calculate a translation vector for the plurality of matched centroids, identify a plurality of matched triplets across three frames from among the plurality of matched centroids, and calculating a rotation for the plurality of matched triplets; and
track the plurality of classified debris objects over a time period.

17. The system as in claim 16, further comprising classifying the plurality of spots as debris objects is performed using a statistical test for differentiating between stars and debris objects in the plurality of spots detected.

18. The system as in claim 17, wherein the statistical test is an extreme Studentized deviate test.

19. A computer readable storage medium having instructions embodied thereon, the instructions when executed by one or more processors, cause the one or more processors to perform a process comprising:
identifying a location and brightness for a plurality of spots in a plurality of image frames from an optical camera;
computing a centroid location for the plurality of spots in the plurality of image frames;
classifying the plurality of spots as debris objects using centroid data from the plurality of image frames to produce a plurality of classified debris objects, by computing a matrix of distances between pairs of centroids across two frames and determining a corresponding matched centroid from among the pairs of centroids to produce a plurality of matched centroids across the two frames, calculating a translation vector for the plurality of matched centroids, and identifying a plurality of matched triplets across three frames from among the plurality of matched centroids, and calculating a rotation for the plurality of matched triplets; and
tracking the plurality of classified debris objects over a time period.

20. The computer readable storage medium as in claim 19, further comprising classifying the plurality of spots as debris objects is performed using a statistical test for differentiating between stars and debris objects in the plurality of spots detected.

21. The computer readable storage medium as in claim 20, wherein the statistical test is an extreme Studentized deviate test.

22. The method of claim 1, further comprising calculating a distance from a median of center of rotations of the plurality of matched triplets.

23. The method of claim 1, wherein the identifying further comprises binarizing each input frame among the plurality of image frames using an intensity threshold (τ) which is dynamically adjusted across successive image frames using a map of the tracked plurality of classified debris objects.
